(19) United States
(12) Patent Application Publication
(10) Pub. No.: US 2020/0410793 A1
(43) Pub. Date: Dec. 31, 2020

(54) PORTABLE POWER BANK, VENDING SYSTEM AND ASSOCIATED METHODS

(71) Applicant: Boomerang iT Corp., Concord (CA)

(72) Inventor: MAURO FOLCO, Richmond Hill (CA)

(21) Appl. No.: 16/455,079

(22) Filed: Jun. 27, 2019

(51) Int. Cl. G07C 9/00; G06K 7/14; G06K 7/10; G06Q 30/06

(52) U.S. Cl. CPC G07C 9/00309; G06K 7/1417; G06Q 20/0453; G06K 7/10366; G06Q 30/0645; G06K 7/10722

(57) ABSTRACT

A portable power bank vending system includes a vending station that selectively “rents” one or more portable power banks. To initiate the rental of a power bank from the vending station, a software application is provided on a smartphone. Once the user confirms he or she desires to rent the power bank via the software application the user scans the QR code using the phone's camera, whereupon a portable power bank is released from the vending station. When the power bank is returned, the camera is used to scan the QR code associated with the same vending station, whereupon the vending station identifies the appropriate storage port in the vending station in which to insert the returned power bank, and the user is charged a fee for the rental.

### TECHNICAL FIELD

The various embodiments disclosed herein relate to vending systems. In particular, the various embodiments disclosed herein relate to vending systems of portable power banks used to charge electronic devices, such as smartphones. More particularly, the various embodiments disclosed herein relate to vending systems of portable power banks, which are rented through communication with the vending system via a user's smartphone.

### BACKGROUND

Portable electronic devices are dependent on battery power to remain functional. However, very often, situations arise where there is a lack of availability of power outlets for charging such portable electronic devices, including smartphones, tablet computers, laptop computers, wireless headphones and the like. For example, in the case of users of smartphones at an airport, it is often common for such users to run down their smartphone's battery so it is no longer operable. As a result, users must either continue without the use of their smartphone or attempt to use a charging cord, which connects their smartphone to an electrical outlet, such as a wall outlet, that is fixed in position in order to recharge their smartphone. However, this tethers the user to the electrical outlet, limiting the ability of the user to freely move around and use his or her smartphone. Furthermore, if there are electrical outlets they are typically limited in number, making it difficult for the surplus of users who need access to such outlets to charge their smartphones. Such a situation is highly inconvenient and undesirable, especially as smartphones are relied upon to perform many essential tasks, such as those tasks performed at retail checkout counters, point-of-sale (POS) terminals and airport gate terminals for example. Thus, the inability to have a charged, functional smartphone or other computing device, such as a tablet computer, is a tremendous inconvenience and severely limits the ability of the user to remain productive and to perform many essential functions. Moreover, the inoperable smartphone or tablet computer may create a potentially dangerous circumstance, as the user may be unable to contact the necessary assistance in an emergency situation.

Therefore, it is highly desirable to provide a system for vending and renting portable power banks to allow users to charge their portable electronic devices, such as mobile phones, smartphones, tablet computers, laptop computers, cameras, wireless headphones and the like.

### SUMMARY

In light of the foregoing, it is a first aspect of the various embodiments disclosed herein to provide a vending station for vending one or more portable power banks comprising a housing having a plurality of ports configured to receive at least one power bank therein, a locking mechanism to selectively control a release of each power bank received within each port, a controller in operative communication with the locking mechanism, and a code configured to be acquired by a portable computing device, the code uniquely identifying the vending station, wherein when the code is acquired by the portable computing device, a computer program application executed on the portable computing device is enabled to communicate with the vending station to selectively release one of the power banks from the port for a predetermined rental time period.

It is a further aspect of the present invention to provide a method of renting a portable power bank comprising providing a vending station having at least one port having a portable power bank received therein, wherein the power bank is selectively released from the port by a locking mechanism, providing a code that uniquely identifies the vending station, providing a portable computing device having a computer program application executed thereon, enabling a first communication between the portable computing device and the vending station upon receipt of the code by the computer program application, selecting a rental option provided by the computer program application, and controlling the locking mechanism to release the power bank.

### BRIEF DESCRIPTION OF THE DRAWINGS

The various embodiments disclosed herein will become better understood with regard to the following description, appended claims and accompanying drawings wherein:

FIG. 1 is a perspective view of a power bank vending system in accordance with the various embodiments disclosed herein;

FIG. 2 is a perspective view of a power bank configured to be electrically coupled to a smartphone for the charging thereof in accordance with the various embodiments disclosed herein;

FIG. 3 is an elevational view of a power bank vending station and user interface provided by an application software program executed on a smartphone in accordance with the various embodiments disclosed herein;

FIG. 4 is a schematic diagram of the components of the power bank vending station in accordance with the various embodiments disclosed herein; and

FIGS. 5A-D are a flow diagram showing the operational steps taken to utilize the power bank vending station and software application program to rent and return a power bank in accordance with the various embodiment disclosed herein.

### DETAILED DESCRIPTION

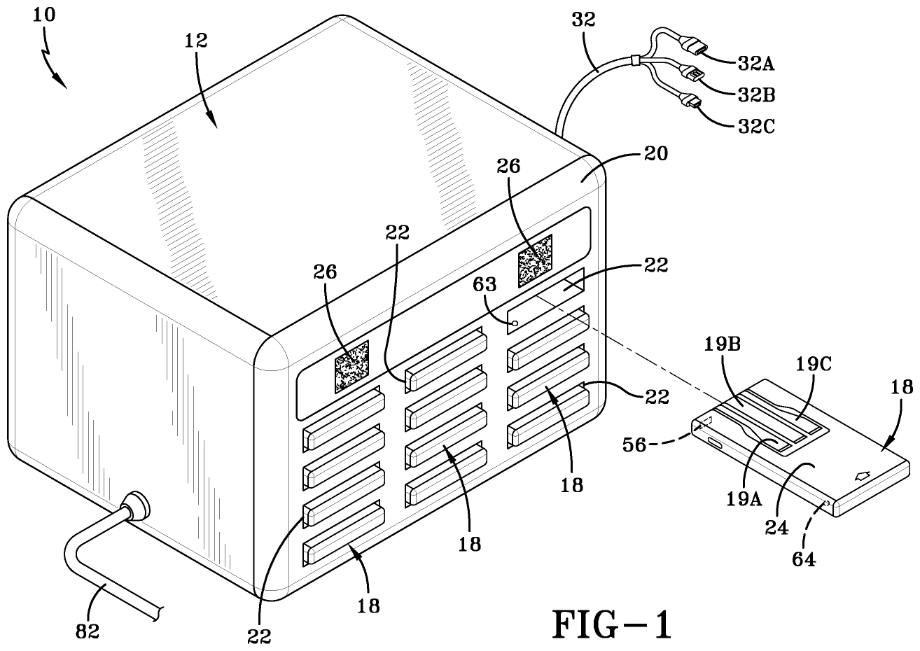

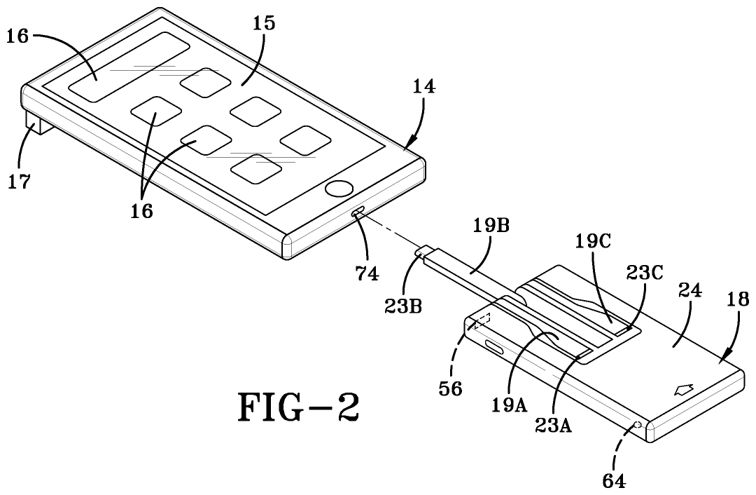

With reference to FIGS. 1-4, one or more embodiments of a power bank vending system 10 are shown. The vending system 10 includes a vending station 12 that contains one or more portable power banks 18 to charge a user's battery-powered portable computing or electronic device, such as a smartphone, portable notebook computer, tablet computer, portable DVD player, wireless headphones or other portable battery-powered electronic device. The vending station 12 is configured to communicate with a portable computing device 14, which includes a viewable display 15, such as an LCD (liquid crystal display), and that has wireless network communication capabilities. For example, the portable computing device 14 may comprise a smartphone, tablet computer or the like. In addition, the portable computing device 14 is configured to execute a computer program application that performs various functions to be discussed, including the generation of an interactive user interface 16 for presentation on the display 15. The vending station 12 is configured to be in communication, such as wired or wireless communication, with the portable computing device 14, whereupon after the initiation of a “rental” option presented by the user interface 16 and the scanning of a code 26, such as a QR code, by a camera 17 of the smartphone 14, the vending station 12 releases the portable power bank 18 from the vending station 12. The user can then utilize the portable power bank 18 to charge their battery-powered computing or electronic device (including device 14), such as their smartphone, as he or she moves freely through their environment, such as an airport, without having to be tethered to a wall power outlet by a traditional charging cord.

### I. Power Bank:

In one or more embodiments, the vending station 12 includes a vending housing 20 having a plurality of storage ports 22 therein. The storage ports 22 comprise cavities that are compatibly dimensioned and shaped to receive therein a respective one of the portable power banks 18. The power banks 18 include a housing 24 having a surface, which may include an antimicrobial film or antimicrobial surface treatment thereon that resists or impedes the growth of bacteria. The housing 24 contains therein a battery power source formed of one or more battery cells, which may utilize any suitable battery chemistry, including but not limited to: Ni-Cad, Li-ion, Li-polymer, Li-Cobalt, Li-Iron phosphate, Li-Nickel Manganese Cobalt and Li-Manganese Oxide. It should be appreciated that the power banks 18 may be configured to have any desired voltage and current performance specifications, so as to be compatible with various battery-powered portable computing or electronic devices, such as smartphones and tablet computers for example.

The power bank 18 also includes one or more electrical charging members 19A-C, which have an electrical conductor that is coupled at one end to the battery source of the power bank 18 and terminated at the other end by any suitable electrical connection interface or connector 23A-C. In some embodiments, the electrical charging members 19A-C may comprise rigid members or arms, such as a conductive member that is enclosed in a rigid housing, or alternatively flexible members, such a wire. In some embodiments, the charging members or arms 19A-C may pivot or rotate relative to the housing 24 of the power bank 18. One of the connection interfaces 23A-C is configured to be attached to a compatible portable computing or electronic device that is desired to be charged, such as the smartphone 14. It should be appreciated that the connection interface 23A-C of the charging members 19A-C may be permanently or removably connected to the battery source of the power bank 18. The connection interfaces 23A-C may comprise any suitable electrical connectors, including but not limited to: an APPLE LIGHTNING electrical connector; and a USB (universal serial bus) electrical connector, including but not limited to USB 1.0, 2.0, 3.0, USB-C, USB-micro, and USB-mini. Accordingly, such connection interfaces 23A-C are capable of being electrically coupled to a charge port 74 of the compatible portable computing or electronic device, such as the smartphone 14, so that it can be charged. In some embodiments, the power bank 18 may be configured without the charging members 19A-C, such that the connection interface 23 comprises a magnetic induction interface (not shown) that is electrically coupled to the battery source of the power bank 18. This allows the power bank 18 to wirelessly charge the portable computing or electronic device, such as the smartphone 14, that is compatible with magnetic inductive charging.

In addition, the power bank 18 includes a charging interface 56, which may comprise any suitable electrical connector, including but not limited to: an APPLE LIGHTNING electrical connector; and a USB (universal serial bus) electrical connector, including but not limited to USB 1.0, 2.0, 3.0, USB-C, USB-micro, and USB-mini. As such, when the power bank 18 is inserted into the storage port 22, the charging interface 56 is configured to be placed in electrical communication with a corresponding counterpart interface 58 provide by the vending station 12. In other embodiments, the charging interface 56 may comprise a magnetic inductive charging interface, which is compatible with a corresponding counterpart inductive charging interface 58 that is provided by the storage port 22 of the vending station 12. Accordingly, when the power bank 18 is inserted into the storage port, the interfaces 56 and 58 electrically communicate to charge the power bank 18.

### II. Vending Station:

The vending station 12 includes the vending housing 20 that provides a controller 50, shown in FIG. 4, which includes the necessary hardware, software or combination thereof to carry out the various functions to be discussed. Coupled to the controller 50 is a wireless communication module 54 that enables communication with the smartphone 14 to enable the various functions of the vending station 12. It should also be appreciated that the controller 50 is in electrical communication with a plurality of charging interfaces 58 via power lines 59 that are each associated with one of the storage ports 22. The charging interfaces 58 are configured to electrically communicate with a corresponding charging interface 56 that is provided by the power bank 18. Accordingly, the controller 50 provides power from a power supply 60 to the particular charging interface 58 to charge the power bank 18 that is inserted in the storage port 22. It should be appreciated that the power supply 60 is configured to be electrically coupled to any suitable power supply that is compatible with the components of system 10. In some embodiments, the power supply 60 is configured to be electrically coupled to an AC (alternating current) electrical receptacle via any suitable electrical connector 82, whereby the AC power is converted into power, such as DC (direct current) power that is compatible for operating the components of the vending system 10 and for charging the power banks 18.

The vending station 12 includes a locking mechanism 61, which may comprise a magnetic locking mechanism, or an electro-mechanical locking mechanism, which is electrically actuated by the controller 50 via control line 62. The locking mechanism 61 serves to selectively control whether the power bank 18 can be removed/released from the storage port 22 by an authorized user. In some embodiments, the vending station 12 includes a locking mechanism 61, which includes an electro-mechanical actuation system, whereby when the controller 50 transmits, or in some cases ceases transmission of a suitable signal via control line 62, an electromechanical solenoid selectively moves a projection 63 member into or out of a cavity 64 provided in the housing 24 of the power bank 18. Thus, the power bank 18 may be placed in a locked state (projection 63 received in cavity 64) relative to the storage port 22, thereby preventing the power bank 18 from being removed therefrom. In addition, the power bank 18 may be selectively placed in a released state (projection 63 not received in cavity 64) relative to the storage port 22 so that the power bank 18 can be freely removed from the corresponding storage port 22 by a user.

In other embodiments, the locking mechanism 61 may utilize magnets in both the power bank 18 and the storage port 22. For example, a magnet that is provided in the storage port 22 may be controlled by the controller 50, such as via control line 62, so that the magnet is controlled to be placed in either of an attractive state or a repulsive state relative to the pole of the magnet in the power bank 18. Thus, when in an attractive state, the magnetic poles of each magnet in the power bank 18 and the storage port 22 are different or opposite to each other, so as to lock the power bank 18 within the storage port 22 so that it cannot be removed. Alternatively, the magnets in the power bank 22 and in the storage port 22 can be controlled by the controller 50 so as to be placed in a repulsive state, such that the magnetic poles of each magnet are the same, resulting in the release of the power bank 18 from the storage port 22 allowing the power bank 18 to be freely removed therefrom by the user.

In some embodiments, the locking mechanism 61 may include a door (not shown) that is positioned proximate to an opening of the port 22. The door is configured to be moved, such as by sliding, by operation of a motor, such as a solenoid, that is under the control of the controller 50 to which the motor is coupled. The motor selectively controls the movement of the door between opened and closed stated to control access to the port 22, and thereby controls the vending and return of the power bank 18 with authorized users of the system 10. In some embodiments, the port 22 opening may be covered by a flexible flap of material, such as a plastic flap for example.

Thus, by actuation by the controller 50, the locking mechanism 61 selectively controls when one or more of the power banks 18 may be removed from the corresponding storage ports 22 of the vending station 12 to which they are received, and therefore serves to allow only authorized users to remove a power bank 18 from the vending station 12 for use.

In one or more embodiments, a unique identification code or data used to identify a specific vending station 12 may be embodied as indicia 26, which is machine readable, such as by a camera 17 provided by the smartphone 14. Such indicia 26 may include a barcode, a quick response (QR) code, or any other suitable code, which is a representation of any data, such as data related to the identification of the vending station 12 and/or the power banks 18. The indicia 26 may be any suitable 2 or 3-dimensional representation of the identification code or data. The data or code embodied by the indicia 26 may be unique to a particular vending station 12, such as a serial number or other unique identifying code to distinguish each of a plurality of vending stations 12 from each other. In other embodiments, the vending station 12 may utilize wireless communication, such as BLUETOOTH or an RFID (Radio Frequency Identification) data tag, instead of the indicia 26, to communicate the identification code associated with the vending station 12 to the smartphone 14 that has a suitable RFID data tag reader. For example, the identification code may represent any code or data, such as serial number and the like. Still yet, in other embodiments, the vending station 12 may utilize an NFC (Near Field Communication) data tag to communicate a vending station 12 serial number or other unique identifying code or any other data to the smartphone 14 that has a suitable NFC reader. In addition, the computer application program that is executed on the phone 14 may communicate various information to the vending station 12, such as a distinctive identifying code or serial number, which uniquely identifies a given phone 14 that is being used with the vending station 12. It should be appreciated that the wired charging connector 32 of the vending station 12 may be used to communicate data between the vending station 12 and the smartphone 14. For example, the identification code, or any other data may be communicated via the connector 32 to the smartphone 14 directly when the smartphone 14 is coupled thereto, such as port 74, which is capable of communicating data.

The vending station 12 is configured to be in wireless network communication with the smartphone 14 via a wireless communication network 30. The wireless communication network 30 may include one or more of the Internet, Local Area Networks (LANs), Personal Area Networks (PANs), Wide Area Networks (WANs), short-range wireless networks, BLUETOOTH networks, WIFI networks, and the like. For example, in some embodiments, one or more remote cloud computing units may be in network communication with the user's smartphone 14 and one or more vending stations 12 to perform one or more functions normally performed by the controller 50. Alternatively, the vending station 12 and the smartphone 14 may be in direct wired communication without the use of the wireless communication network 30, such as through the cable or wired charging connector 32. In other embodiments, the vending station 12 and smartphone 14 may be in direct wireless network communication via one or more Local Area Networks (LANs), Personal Area Networks (PANs), Wide Area Networks (WANs), short range wireless networks, as well as BLUETOOTH networks, WIFI networks, and the like.

The vending station 12 also includes a wired charging cable or connector 32, which provides one or more interface adapters 32A-C for connecting to the charging interface 74 of the smartphone 14. This wired charging cable 32 provides a short-term supply of power to a smartphone 14, which may have low battery power or that has no battery power. The wired charging cable 32 thus supplies power to the smartphone 14 so that it can remain or become operational to allow the download of the necessary software program application in order that the user can obtain through renting a power bank 18 from the vending station 12. In some embodiments, the software program application may be downloaded to the smartphone 14 from the vending station 12 or from another remote computer via a wired or wireless communication network, including the wireless network 30. It should be appreciated that in some embodiments, the charging cable 32 is configured to provide an amount or magnitude of charging power to the portable electronic device 14 that is less than the amount of power that is delivered by the power bank 18 to the portable electronic device 14 when coupled thereto. In other embodiments, the vending station 12 may include a wireless magnetic inductive charger, which is capable of wirelessly charging a compatible smartphone 14 to provide an amount or magnitude of charging power to the portable electronic device 14 that is less than the amount of power that is delivered by the power bank 18 to the portable electronic device 14 when coupled thereto. Again, the power that is delivered to the smartphone 14 inductively is to allow the smartphone 14 to have an amount of power that is sufficient to enable it to operate to download the software program application needed to complete the vending process at the vending station 12. Thus, the power delivered via the charging cable 32 may be limited in time, or in magnitude (current and/or voltage). In addition, the controller 50 may identify an identifying code associated with the smartphone 14 that when it is first coupled to the vending station 12 via the charging cable 32. As a result, the controller 50 prevents repeated or successive attempts to charge the same smartphone 14 over and over using the same using the charging cable 32, so as to circumvent the rental of the power bank 18. For example, the controller 50 may restrict delivery of charging power via the charging cable 32 so that a 30 minute period must separate successive charges via the charging cable 32. However, it should be appreciated that any suitable time period or limit, as well as no time limit may be used. It should be appreciated that the controller 50 may execute a timer upon the attachment of the portable electronic device 14 to the charging cable 32 or to the inductive charger, whereupon after a predetermined amount of time, the controller 50 terminates the supply of power.

### III. Software Program Application/User Interface of Mobile Application:

The user of the system 10 utilizes the interactive graphical user interface 16 generated by the software program application or mobile application in order to obtain the power bank 18 from the vending station 12. For example, the user interface 16 provided on the display 15 may be interacted with via the touch of a person's finger. In one or more embodiments, the smartphone 14 may download the software program application by a separate connection to the communication network 30. In other embodiments, whether by the external cable 32 or the wireless network 30 to the vending station 12, which may or may not include connection to the Internet, the data connection between the smartphone 14 and the vending station 12 may be used to download the software program application from the vending station 12 to the phone 14; or to initiate the download of the application from a location that is remote from the vending station 12. In some cases, the vending station 12 may download the software application from a remote computer system, whereupon it is delivered to the phone 14 via the cable 32.

The graphical user interface 16 generated by the software program application includes various user selectable options and data fields for the user to enter their personal information, including payment information, such as credit/debit card information, promotion codes, as well as information regarding any electronic payment service, such as PAYPAL, APPLE PAY, WE CHAT PAY, ALI PAY, and the like. In addition, the data fields may include information relating to registration and/or authentication requirements for the user of the phone 14. These registration and/or authentication requirements may include one or more of the user's name, phone number, user's biometric information (thumbprint, face, etc.) e-mail address, and payment information, and the like for example.

The interface 16 may present information related to where one or more vending station 12 are located. This location information may include a graphical map view and/or GPS coordinates identifying where one or more vending stations 12 are located. Thus, the interface 16 may assist the user in locating the vending station 12 at any time. When multiple vending stations 12 are utilized at different locations, such location information may be presented on the interface 16 and may direct the user to the vending station 12 closest to him or her. This location information, including graphical map information, may also indicate where the power bank 18 needs to be returned, in the event that the user has left the location of the vending station 12. In one or more embodiments, multiple vending stations 12 may be utilized in a particular region or location, such as at the DISNEY WORLD® theme park. Thus, the system 10 may be configured so that the power bank 18 obtained from one vending station 12 may be returned to another vending station other than the original vending station 12 from which it was rented.

The software mobile application or mobile application may include the ability to read, acquire, and process other data represented or embedded by or in the indicia 26 or communicated to the smartphone 14 from the vending station 12. As further discussed herein, this generally includes utilizing the camera 17 of the phone 14 to read the indicia 26 and obtain the data therefrom to be processed by the mobile application.

The mobile application may display, via the interface 16, information related to the use of the power bank 18. For example, the interface 16 may indicate on a timer shown on the display 15 the amount of time that the power bank 18 has been removed from the vending station 12 when it was rented, as well as the charge state of the power bank 18. The application software may also indicate a current cost owed by the user for the use of the power bank 18. In some embodiments, this cost of the rental may be based on the amount of time the power bank 18 has been removed from the vending station 12. The interface 16 may also provide audio (speakers provided by the device 14), visual, or audio/visual confirmation to the user when the power bank 18 has been returned to the vending station 12.

In one or more embodiments, the mobile application may display, via the interface 16, a coupon or promotional code for goods or services based on the location where the vending station 12 is located. This encourages a user of the mobile application to utilize a particular vending station 12 based on a desire to receive/utilize the corresponding coupon.

### IV. Method of Operation:

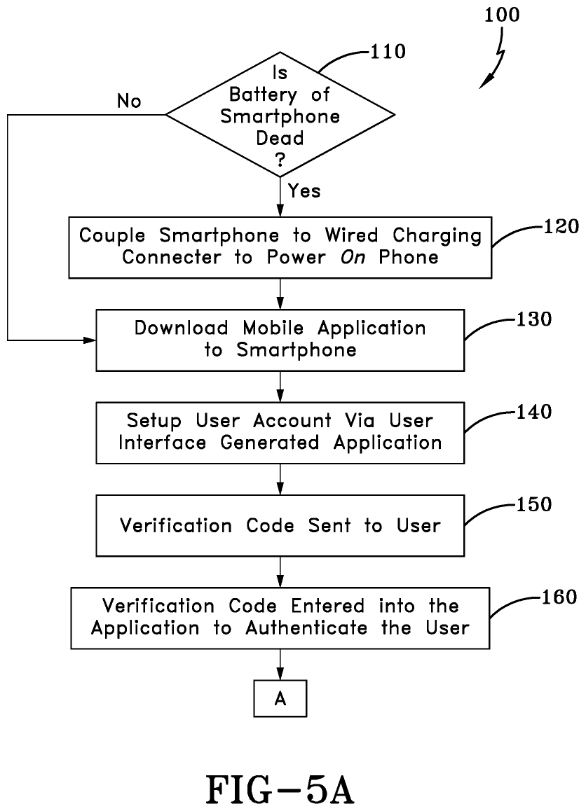

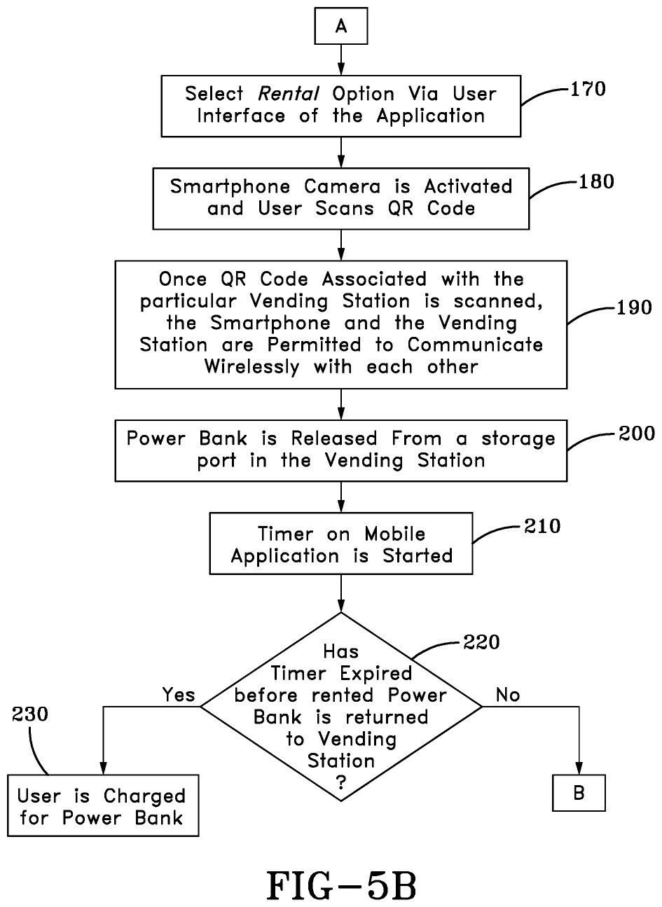

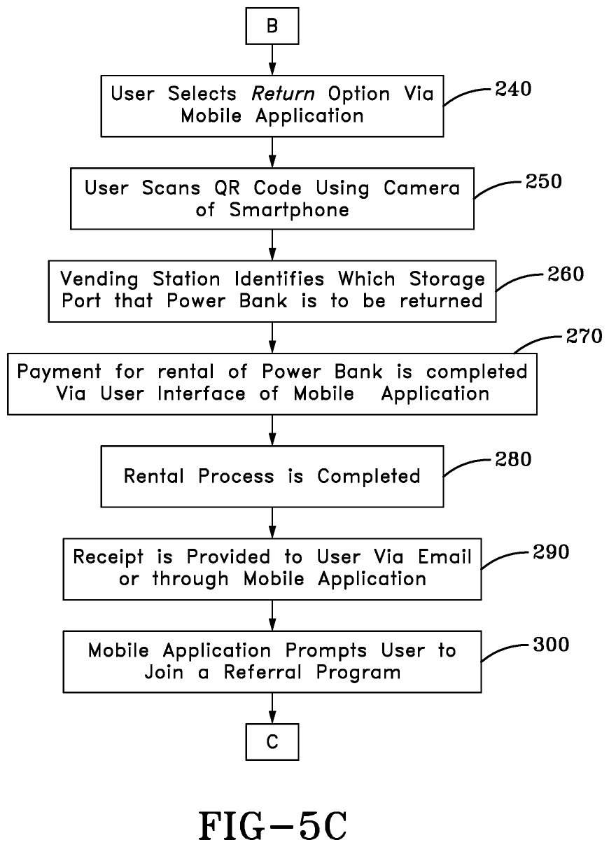

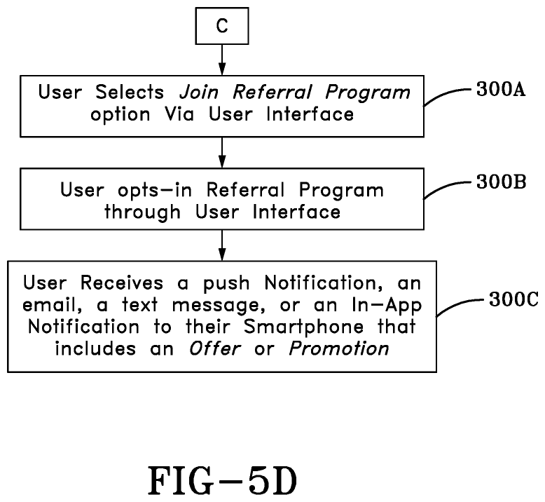

A method for operating the vending system 10, is generally referred to by the numeral 100, as shown in FIGS. 5A-D. Initially, at step 110, if the smartphone 14 is inoperable because its battery is drained, the process 100 proceeds to step 120. At step 120, the user attaches the charging cable 32 using the suitable connector 32A-C to the charging interface 74 of the smartphone 14. During this step, the smartphone 14 is charged, such as at a rate that is slower than the charge rate that is supplied by the electrical current of the power bank 18. Thus, the charging cable 32 provides just enough power to enable the smartphone 14 to power “ON”. Once the smartphone 14 is powered “ON”, the smartphone 14 is operated to download the software program application, such as from a website or other remote host, including the APPLE APP STORE, or the GOOGLE PLAY STORE for example, as indicated at step 130. In some embodiments, the software program application may be downloaded directly from the vending station 12 to the smartphone 14. It should also be appreciated that if at step 110 that the smartphone 14 has sufficient battery charge that the process 100 proceeds directly to step 130, whereupon the software program application is downloaded.

Continuing, to step 140, the user interface 16 presented on the display 15 of the smartphone 14 may request that the user create a user account by inputting various information into various data fields in the user interface 16. The user account may include various information, including but not limited to: the user's name, user's address, user's phone number, payment information, including credit/debit card information, as well as information regarding any electronic payment service such, as PAYPAL, APPLE PAY, WE CHAT PAY, ALI PAY, and the like. It should be appreciated that this account information or data may be stored at a remote computer system that is in wired or wireless network communication with the vending station 12. Once a user account is completed, the process 100 proceeds to step 150, where a verification code is sent to the user's smartphone 14 that is being used to set up the user account. The verification code may be sent to the user, including their smartphone 14, via text message, email, voice/phone, or any suitable method. Once the verification code is received, the user enters it into the appropriate data entry field of the user interface 16 of the mobile application to authenticate the user, as indicated at step 160. Next, at step 170, the user may select, via the user interface 16, a “Rental” option to initiate the rental of a power bank 18 form the vending station 12, whereupon an indicia-scanning mode of the mobile application activates the camera 17 of the smartphone 14 to optically scan the indicia 26 associated with the vending station 12, as indicated at step 180. As previously discussed, the indicia 26 may comprise a QR code. Upon scanning the indicia 26, the mobile application obtains the data embodied in the indicia 26, which data includes information to identify the particular vending station 12. This scanning of the indicia 26 also enables wireless network communication between the specific vending station 12 and the smartphone 14, as indicated at step 190. However, this step of establishing communication may be performed through the charging cable 32 at step 120. In addition, the data may be accessed from the remote computer system via a suitable graphical user interface, such as that provided by a web browser for example.

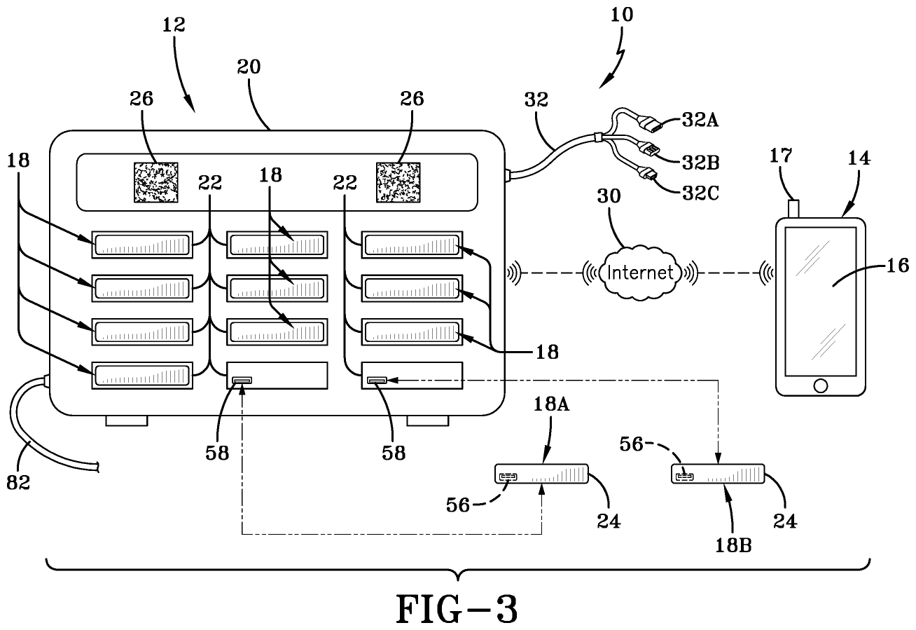

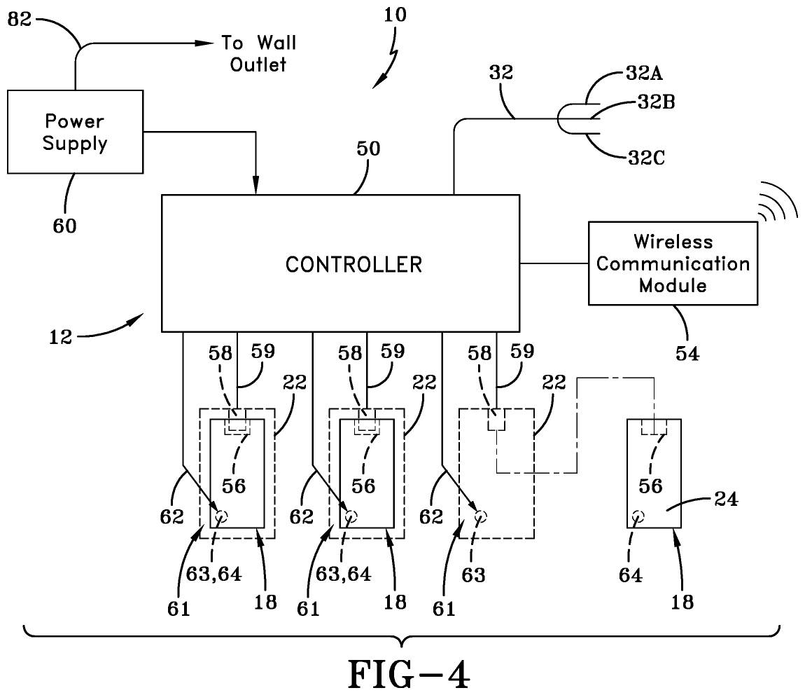

After scanning the indicia 26, the process proceeds to step 200 where the controller 50 of the vending station 12 communicates with a respective one of the storage ports 22 in order to command the locking mechanism 61 to release a power bank 18A therefrom, as shown in FIG. 3, that has been fully charged. The user may then utilize the charged power bank 18A with the smartphone 14 to charge or to otherwise extend the operating power of their smartphone 14 in the manner to be discussed. Somewhat simultaneously with step 200, step 210 is initiated, whereupon a timer is started at one or more of the controller 50 and mobile application, which identifies the total amount of time that has elapsed since the power bank 18A has been released from the vending station 12.

As mentioned above, the user interface 16 of the mobile application may present various information to the user relating to the use of the power bank 18A, which may include the amount of time elapsed since the power bank 18A has been released by the vending station 12, as well as the cost of renting the power bank 18A, and the cost associated with the failure of returning the power bank 18A to the vending station 12 before a predetermined time, as measured by the timer.

As the charged power bank 18A is used, step 220 is performed to determine if the timer that has been started at step 210 has expired before the power bank 18 has been returned back to the vending station 12 from which it was initially rented. If the timer has expired before the power bank 18 has been returned to the vending station 12, then the process proceeds to step 230, where the user is charged the full price for the power bank 18 (and is permitted to keep the power bank) using the payment information provided as part of their user account. Alternatively, if the timer has not expired before the user has returned the power bank 18 to the vending station 12 at step 220, the process proceeds to step 240. At step 240, the user may select a “Return” option from the user interface 16 of the mobile application. Next, at step 250, the indicia-scanning mode of the mobile application activates the camera 17 of the smartphone 14 to scan the indicia 26, such as a QR code associated with the vending station 12 to which the power bank 18 is being returned. It should be appreciated that the code 26 may be attached to the vending station 12 or may be provided separate from the vending station. As mentioned above, this may be the same vending station 12 or a different vending station (not shown) as the original vending station 12. At step 260, the vending station 12 identifies a particular storage port 22 and controls the locking mechanism 61 to allow the returned power bank 18B to be inserted therein. Upon insertion of the used power bank 18B into the port 22, as shown in FIG. 3, the mobile application stops the timer and payment for the power bank 18 rental is completed, as indicated at step 280. It should be appreciated that in some embodiments, the amount of the payment for the power bank 18 rental is based on the elapsed time of usage of the power bank 18, or alternatively, may be a flat or fixed amount. In addition, a receipt for the transaction may be provided to the user via email, text message notification, or the user interface 16, as indicated at step 290.

Furthermore, at step 300, the mobile application may optionally prompt the user via the user interface 16 to join a referral program. As such, if the user selects a “Join Referral Program” option via the user interface 16 at step 300A, the process 100 proceeds to step 300B, where the user is prompted to enter information, such as a promotion or referral code, to opt-in to the “Referral Program”. Once the information is entered at step 300B and the user is enrolled into the “Referral Program”, the process proceeds to step 300C. At step 300C, the user will receive, for being enrolled in the “Referral Program”, one or more various notifications that include an offer or promotion. For example, the offer or promotion may include a discount, such as a coupon on a product or service. In some embodiments, the coupon may be for the products or services associated with the business that is providing or hosting a specific vending station 12. It should be appreciated that the offer or promotion may be communicated to the user's smartphone 14 via a notification, such as a push notification, or a text message, an email message sent the email address used to set up their user account, or an in-app notification displayed via the user interface 16 of the mobile application. In further embodiments, at step 300C a referral code may be communicated to the user's smartphone 14 via a notification, such as a push notification, or through other means, such as a text message, or an email message that is sent the email address or phone 14 that is used to set up their user account. In addition, the notification may be communicated to the user via an in-app notification displayed via the user interface 16 of the mobile application. This referral code may then be shared by the user with others via any suitable communication method, such as by email, text message, and the like. This referral code can then be used to obtain a discount on a rental of the power bank 18, or to obtain other discounts or offers. It should be appreciated that in some embodiments, when the referral code is used by another, the originator or supplier of the referral code earns a commission fee.

Therefore, it can be seen that the objects of the various embodiments disclosed herein have been satisfied by the structure and its method for use presented above. While in accordance with the Patent Statutes, only the best mode and preferred embodiments have been presented and described in detail, with it being understood that the embodiments disclosed herein are not limited thereto or thereby. Accordingly, for an appreciation of the true scope and breadth of the embodiments, reference should be made to the following claims.

What is claimed is:

1. A vending station for vending one or more portable power banks comprising:
a housing having a plurality of ports configured to receive at least one power bank therein;
a locking mechanism to selectively control a release of each power bank received within each port;
a controller in operative communication with the locking mechanism; and
a code configured to be acquired by a portable computing device, said code uniquely identifying the vending station;
wherein when said code is acquired by the portable computing device, a computer program application executed on the portable computing device is enabled to communicate with the vending station to selectively release one of the power banks from the port for a predetermined rental time period.

2. The vending station of claim 1, wherein said controller is configured to selectively charge the power bank received within the port.

3. The vending station of claim 2, further comprising a wired charging connector in operative communication with said controller, said charging connector configured to be selectively coupled to a charging interface of the portable computing device to provide charging power for a predetermined amount of time.

4. The vending station of claim 1, wherein said locking mechanism comprises a solenoid.

5. The vending station of claim 1, wherein said code is provided by an indicia or a radio frequency identification (RFID) tag.

6. The vending station of claim 5, wherein said code is a quick response (QR) code.

7. The vending station of claim 3, wherein said code is capable of being communicated through said wired charging connector.

8. A method of renting a portable power bank comprising:
providing a vending station having at least one port having a portable power bank received therein, wherein said power bank is selectively released from said port by a locking mechanism;
providing a code that uniquely identifies said vending station;
providing a portable computing device having a computer program application executed thereon;
enabling a first communication between the portable computing device and said vending station upon receipt of said code by said computer program application;
selecting a rental option provided by said computer program application; and
controlling said locking mechanism to release said power bank.

9. The method of claim 8, wherein said vending station selectively charges the power bank received within the port.

10. The method of claim 8, wherein said locking mechanism comprises a solenoid.

11. The method of claim 8, wherein said code is provided by an indicia or a radio frequency identification (RFID) tag.

12. The method of claim 11, wherein said code is a quick response (QR) code.

13. The method of claim 8, wherein said code is communicated through a wired charging connector provided by the vending station.

14. The method of claim 8, further comprising:
starting a timer when the power bank has been released;
selecting a return option prior to the expiration of said timer;
enabling a second communication between the portable computing device and said vending station upon receipt of said code by said computer program application; and
controlling said locking mechanism to permit the receipt of the power bank in the port.

15. The method of claim 14, further comprising:
placing the power bank within said port; and
completing payment for a rental of the power bank.

16. The method of claim 15, further comprising:
communicating a receipt to the portable computing device that includes a discount code.

17. The method of claim 8, further comprising:
starting a timer when the power bank has been released; and
completing payment for a purchase of the power bank if the power bank is not returned to the vending station prior to the expiration of said timer.
